(19) United States
(12) Patent Application Publication
(10) Pub. No.: US 2009/0077606 A1
(43) Pub. Date: Mar. 19, 2009

(54) AUDIO/VIDEO TRANSMISSION APPARATUS AND AUDIO/VIDEO TRANSMISSION METHOD

(76) Inventors: Shinobu Machida, Kyoto (JP); Kiyotaka Iwamoto, Kyoto (JP)

Correspondence Address: MCDERMOTT WILL & EMERY LLP, 600 13TH STREET, NW, WASHINGTON, DC, 20005-3096, US

(21) Appl. No.: 12/207,117

(22) Filed: Sep. 9, 2008

(30) Foreign Application Priority Data
Sep. 13, 2007 (JP) 2007-237890

(51) Int. Cl. H04N 7/173

(52) U.S. Cl. 725/118

(57) ABSTRACT

An audio/video transmission apparatus includes a hot plug detecting section for detecting a hot plug signal output from a reception apparatus connected thereto via an High Definition Multimedia Interface (HDMI), an EDID reading/determining section for determining Extended Display Identification Data (EDID) information of the reception apparatus, a type determining section for determining a type of the reception apparatus based on a result of the determination of the EDID information, a TMDS switching section for designating an output scheme corresponding to the type of the reception apparatus of a plurality of Transition Minimized Differential Signaling (TMDS) signal output schemes; and a TMDS output section for outputting a TMDS signal in accordance with the designated output scheme.

### BACKGROUND OF THE INVENTION

1. Field of the Invention

The present invention relates to an audio/video transmission apparatus and an audio/video transmission method including a high-speed interface for transmitting audio and video information.

2. Description of the Related Art

A serial transmission interface called a High Definition Multimedia Interface (HDMI) for transmitting audio/video information is well known.

FIG. 6 is a diagram showing a configuration of a conventional audio/video transmission apparatus and a conventional audio/video reception apparatus. FIG. 6 shows the audio/video transmission apparatus 600 and the audio/video reception apparatus 630, which are connected to each other via an HDMI cable 680. The audio/video transmission apparatus 600 is any of a DVD player, an HD recorder and the like. The audio/video reception apparatus 630 is any of a television set, a projector, an AV amplifier and the like.

In FIG. 6, 640 indicates a storage element (memory) for storing Extended Display Identification Data (EDID) information, 651 indicates a Transition Minimized Differential Signaling (TMDS) input section for receiving a TMDS signal from the external audio/video transmission apparatus 600 connected thereto, 652 indicates a hot plug output section for outputting a hot plug signal to the external audio/video transmission apparatus 600 connected thereto, 650 indicates an HDMI processing section including the TMDS input section 651 and the hot plug output section 652, 660 indicates an audio/video processing section for performing various audio/video processes, and 670 indicates an audio/video output section for outputting audio and video that have been processed by the audio/video processing section 660. The audio/video reception apparatus 630 has an input section (not shown) for receiving a desired control item, as well as the storage element 640, the HDMI processing section 650, the audio/video processing section 660, and the audio/video output section 670.

On the other hand, 611 indicates an EDID reading/determining section for reading out EDID information from the storage element 640 and determining a content of the EDID information, 612 indicates a hot plug detecting section for detecting a hot plug signal from the hot plug output section 652, 613 indicates a TMDS output section for outputting a TMDS signal to the TMDS input section 651, 610 indicates an HDMI processing section including the EDID reading/determining section 611, the hot plug detecting section 612, and the TMDS output section 613, and 620 indicates an audio/video processing section for performing various audio/video processes. The audio/video transmission apparatus 600 has an input section (not shown) for receiving a desired control item, a tuner (not shown), and an audio/video recording/reproducing section (not shown) for recording audio and video received via the tuner or reproducing recorded audio and video, as well as the HDMI processing section 610 and the audio/video processing section 620. Note that signal lines of the HDMI cable 680 that are not herein described are not shown.

FIG. 7 shows a TMDS signal output scheme of the TMDS output section 613. The audio/video transmission apparatus 600 and the audio/video reception apparatus 630 are connected to each other via the HDMI cable 680. When both the apparatuses 600 and 630 are powered ON, the hot plug output section 652 causes a hot plug signal to go from Low to High. The hot plug detecting section 612, when detecting the transition of the hot plug signal from Low to High, determines that the audio/video transmission apparatus 600 is physically connected to the audio/video reception apparatus 630, and EDID information can be read out, and instructs the EDID reading/determining section 611 to read out EDID information from the storage element 640.

The EDID reading/determining section 611 reads out EDID information from the storage element 640, and based on a content of the EDID information, determines whether the audio/video reception apparatus 630 is an HDMI apparatus, a Digital Visual Interface (DVI) apparatus, or other unknown apparatuses. When determining that the audio/video reception apparatus 630 is an HDMI apparatus, the EDID reading/determining section 611 instructs the TMDS output section 613 to output a TMDS signal.

As shown in FIG. 7, the TMDS output section 613 outputs the TMDS signal in the following procedure. The TMDS signal is output for a period of t1, then stopped for a period of t2, and then continuously output. An InfoFrame packet is output at a timing “P1” that is a time after a period of t3 has elapsed since the start of the continuous output. An authentication process is started at a timing “P2”. Output of audio/video information is started at a timing “P3” at which the authentication process is ended. The audio/video information is either one that has been received by the tuner or one that has been reproduced by the audio/video recording/reproducing section. The input section selects either one of the pieces of audio/video information, and also selects the type of audio, the resolution of output video and the like. The audio/video processing section 620 processes the audio/video information into a desired audio type and video resolution and outputs the resultant data to the TMDS output section 613.

Note that the time periods t1, t2 and t3 each have a fixed value, so that only a single TMDS signal output scheme is available irrespective of the type, manufacturer, model and the like of the connected audio/video reception apparatus 630.

The audio/video reception apparatus 630 processes the received audio/video information into audio and video that can be listened and viewed using the audio/video processing section 660, and outputs the resultant data to the audio/video output section 670. Stages following the audio/video output section 670 vary depending on whether the audio/video reception apparatus 630 is a television set, a projector, or an AV amplifier, and will not be described. Also, a case where it is determined that the audio/video reception apparatus 630 is a DVI apparatus or other unknown apparatuses, will not be described.

Incidentally, in the configuration described above, the TMDS signal output scheme and the InfoFrame packet output timing are fixed. Therefore, a mismatch in process timing may occur between the sender and the receiver, depending on the connected audio/video reception apparatus, so that a defective phenomenon may occur, e.g., the authentication process may fail, audio may not be output or a discomfort sound may be generated, video may not be output or may be disturbed, or the like.

To avoid this, an audio/video transmission apparatus according to a conventional technique determines the type of a reception apparatus connected thereto based on EDID information including product information, manufacturer information, and video format information, and switches a control program only for a specific type. Thereby, even if the reception apparatus causes a hot plug signal to go from High to Low without holding the hot plug signal (without fixing the hot plug signal to High) while an authentication process is being performed, the transition is ignored and the authentication process is continued, so that a defective phenomenon is prevented (see Japanese Unexamined Patent Application Publication No. 2006-203725).

### SUMMARY OF THE INVENTION

The defective phenomena described above may often be reduced by adjusting the TMDS signal output scheme and the InfoFrame packet output timings (t1, t2 and t3 of FIG. 7) in the audio/video transmission apparatus. However, the adjustment of the timings t1, t2 and t3 has a side effect that a similar defective phenomenon occurs in an audio/video reception apparatus that would otherwise be conventionally free of such a problem.

Also, in order to secure the quality of a conventional apparatus every time the timings t1, t2 and t3 are adjusted, connection to the audio/video reception apparatus that would otherwise be conventionally free of the problem needs to be verified again so as to confirm that there is not the side effect. This process requires a vast time that is proportional to the number of apparatuses to be verified and the number of items to be evaluated.

In view of the problems described above, the present invention has been achieved. An object of the present invention is to provide an audio/video transmission apparatus having a plurality of output schemes in which the type of a reception apparatus is determined based on EDID information read out from an audio/video reception apparatus connected thereto, and a TMDS signal and an InfoFrame packet corresponding to the type can be output.

To achieve the object, the present invention provides an audio/video transmission apparatus connectable to an audio/video reception apparatus via a serial transmission interface, including a section for determining a type of the audio/video reception apparatus based on apparatus information about the connected audio/video reception apparatus, and a section for selecting an information transmission signal output scheme corresponding to the type of the connected audio/video reception apparatus from a plurality of output schemes for an information transmission signal, and outputting the information transmission signal.

More specifically, the present invention provides an audio/video transmission apparatus connectable to an audio/video reception apparatus via an HDMI interface, including a hot plug detecting section for detecting a hot plug signal output from the connected audio/video reception apparatus, an EDID reading/determining section for reading EDID information of the connected audio/video reception apparatus, and determining a content of the EDID information, a type determining section for determining a type of the connected audio/video reception apparatus based on a result of the determination of the EDID information, a TMDS switching section for designating an output scheme corresponding to the type of the connected audio/video reception apparatus of a plurality of TMDS signal output schemes, and a TMDS output section for outputting a TMDS signal in accordance with the output scheme designated by the TMDS switching section.

According to the present invention, as compared to the conventional single-output scheme, a mismatch in process timing between the sender and the receiver can be reduced, thereby making it possible to reduce a phenomenon due to the mismatch, such as a failure in authentication, the absence or disturbance of audio or video output, or the like.

### BRIEF DESCRIPTION OF THE DRAWINGS

FIG. 1 is a block diagram showing a configuration of an audio/video transmission apparatus according to the present invention and an audio/video reception apparatus.

FIGS. 2A to 2D are diagrams showing various TMDS signal output schemes and various InfoFrame packet output timings in the audio/video transmission apparatus of FIG. 1.

FIG. 3 is a flowchart of a process of determining the type of the reception apparatus in the audio/video transmission apparatus of FIG. 1.

FIG. 4 is a diagram showing a structure of an extension block of EDID information held by a storage element of FIG. 1.

FIG. 5 is a block diagram showing a detailed configuration of a TMDS switching section of FIG. 1.

FIG. 6 is a block diagram showing a configuration of a conventional audio/video transmission apparatus and a conventional audio/video reception apparatus.

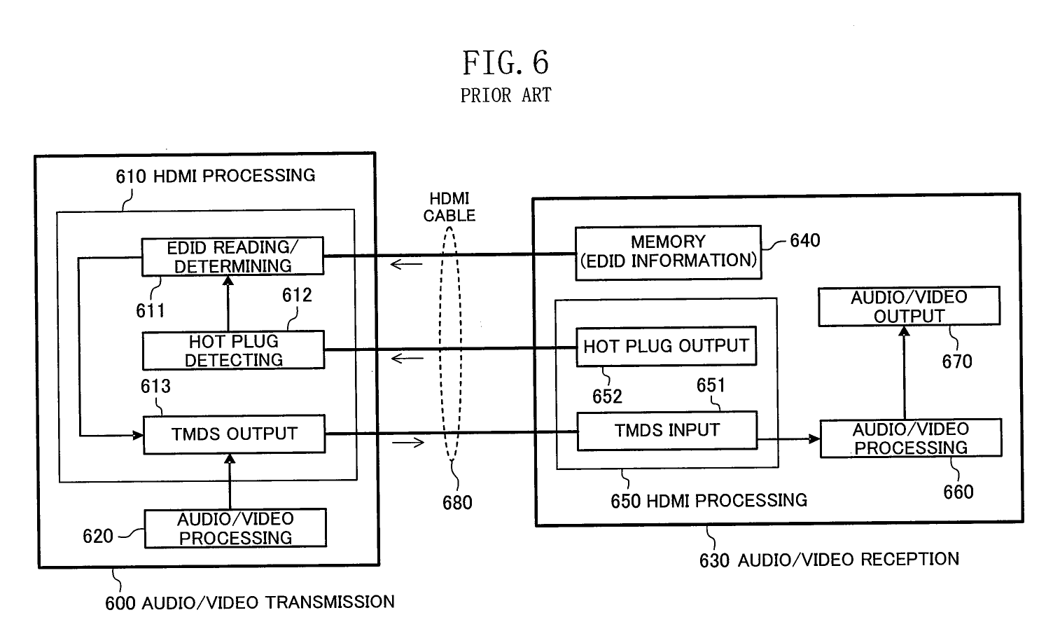

FIG. 7 is a diagram showing a TMDS signal output scheme and an InfoFrame packet output timing in the audio/video transmission apparatus of FIG. 6.

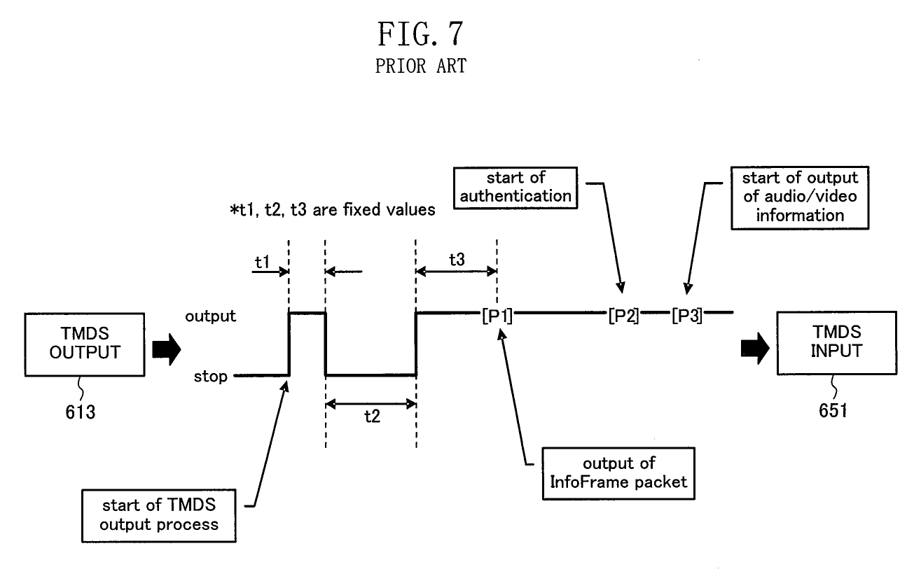

### DETAILED DESCRIPTION OF THE PREFERRED EMBODIMENTS

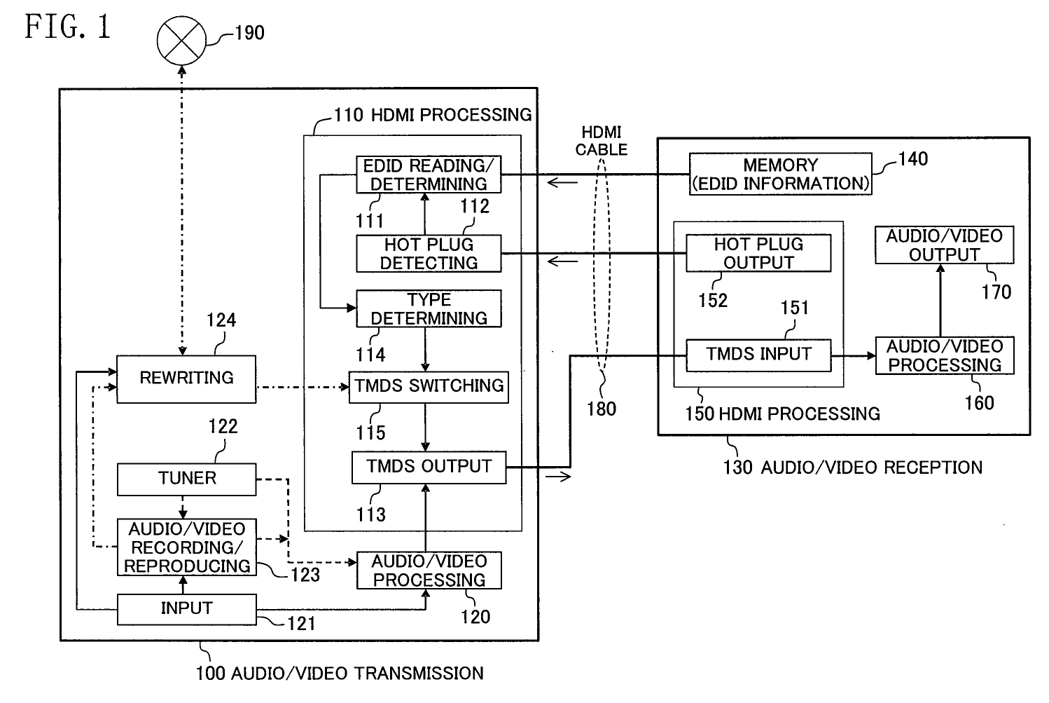

FIG. 1 is a diagram showing a configuration of an audio/video transmission apparatus according to the present invention and an audio/video reception apparatus. FIG. 1 shows the audio/video transmission apparatus 100 and the audio/video reception apparatus 130, which are connected to each other via an HDMI cable 180. The audio/video transmission apparatus 100 is any of a DVD player, an HD recorder and the like. The audio/video reception apparatus 130 is any of a television set, a projector, an AV amplifier and the like. Note that the present invention may be implemented by hardware or software, or in combination of hardware and software.

In FIG. 1, 140 indicates a storage element (memory) for storing EDID information, 151 indicates a TMDS input section for receiving a TMDS signal from the external audio/video transmission apparatus 100 connected thereto, 152 indicates a hot plug output section for outputting a hot plug signal to the external audio/video transmission apparatus 100 connected thereto, 150 indicates an HDMI processing section including the TMDS input section 151 and the hot plug output section 152, 160 indicates an audio/video processing section for performing various audio/video processes, and 170 indicates an audio/video output section for outputting audio and video processed by the audio/video processing section 160. The audio/video reception apparatus 130 has an input section (not shown) for receiving a desired control item, as well as the storage element 140, the HDMI processing section 150, the audio/video processing section 160, and the audio/video output section 170.

On the other hand, 111 indicates an EDID reading/determining section for reading out EDID information form the storage element 140 and determines a content of the EDID information, 112 indicates a hot plug detecting section for determining a hot plug signal from the hot plug output section 152, 113 indicates a TMDS output section for outputting a TMDS signal to the TMDS input section 151, 114 indicates a type determining section for determining the type of the audio/video reception apparatus 130, 115 indicates a TMDS switching section that includes a plurality of output schemes and a plurality of InfoFrame packet output timings for the TMDS signal output from the TMDS output section 113, and switches the output schemes and the InfoFrame packet output timings, 110 indicates an HDMI processing section including the EDID reading/determining section 111, the hot plug detecting section 112, the TMDS output section 113, the type determining section 114, and the TMDS switching section 115, 120 indicates an audio/video processing section for performing various audio/video processes, 121 indicates an input section for providing a desired setting, 122 indicates a tuner, 123 indicates an audio/video recording/reproducing section including a hard disk drive (hereinafter referred to as an HDD), a CD/DVD drive or the like that records audio and video received by the tuner 122 or reproduces recorded audio and video, and 124 indicates a rewrite section for rewriting the TMDS signal output schemes and the InfoFrame packet output timings possessed by the TMDS switching section 115. The audio/video transmission apparatus 100 includes the HDMI processing section 110, the audio/video processing section 120, the input section 121, the tuner 122, the audio/video recording/reproducing section 123, and the rewrite section 124. 190 indicates a communications network, such as the Internet or the like. Note that signal lines of the HDMI cable 180 that are not herein described are not shown.

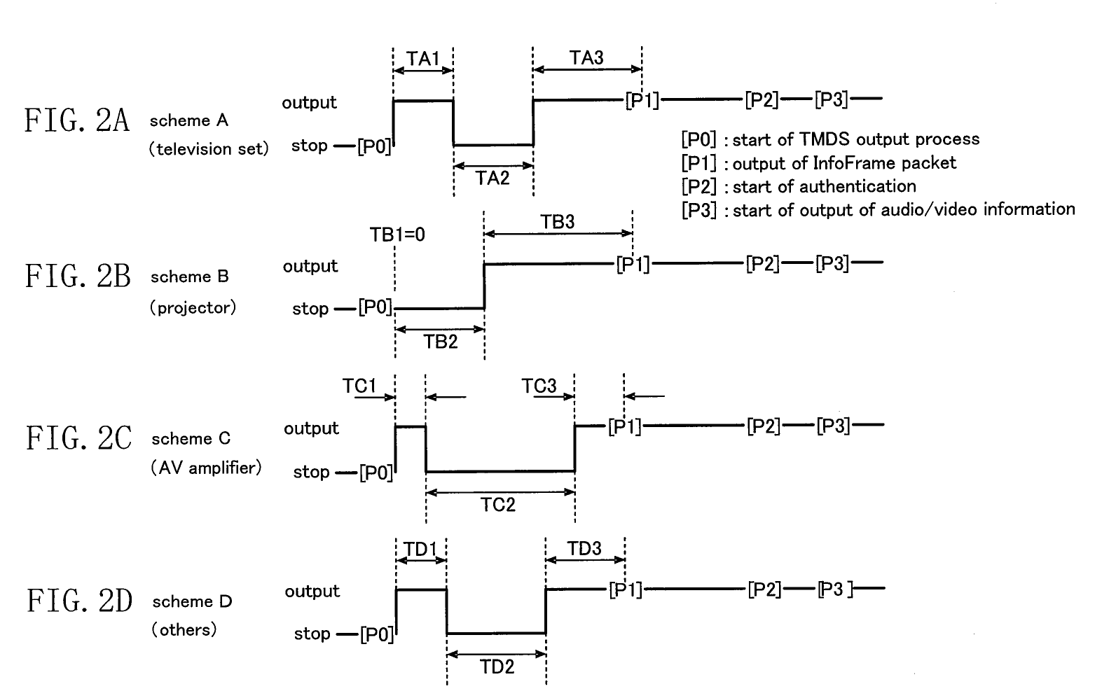

FIGS. 2A to 2D show output schemes of a TMDS signal that is output by the TMDS switching section 115 to the TMDS output section 113 for instruction. The output schemes are provided, corresponding to respective types of the audio/video reception apparatus 130 (i.e., a television set, a projector, an AV amplifier, and others).

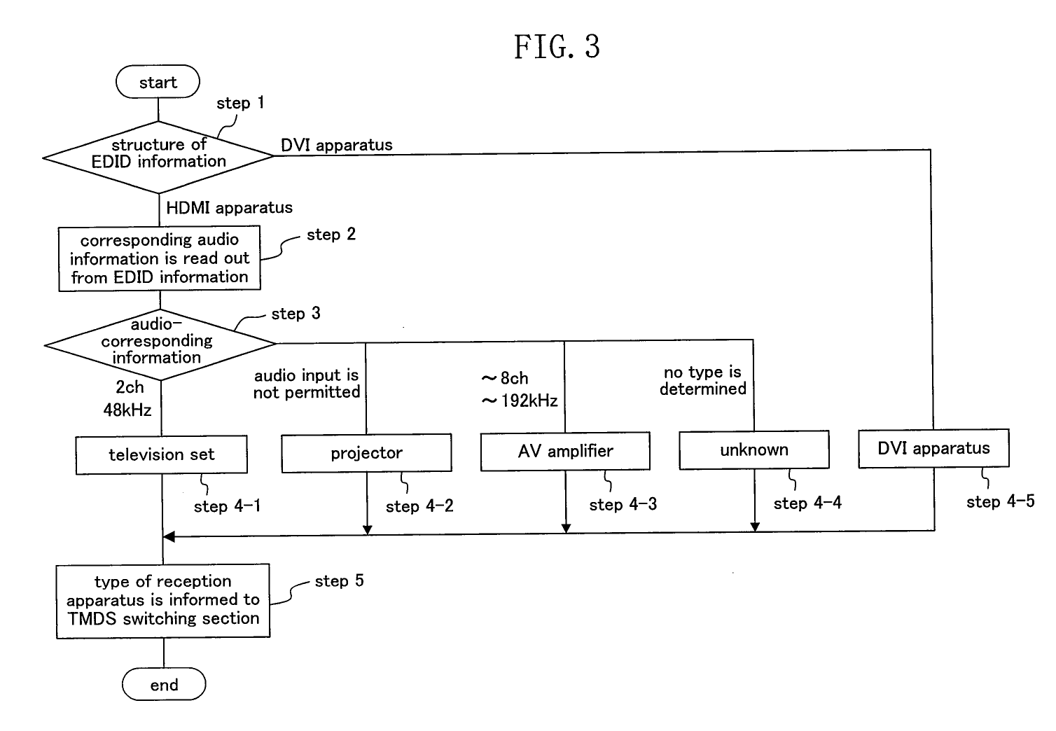

FIG. 3 is a flowchart of a process of determining the type of the audio/video reception apparatus 130 using the EDID reading/determining section 111 and the type determining section 114.

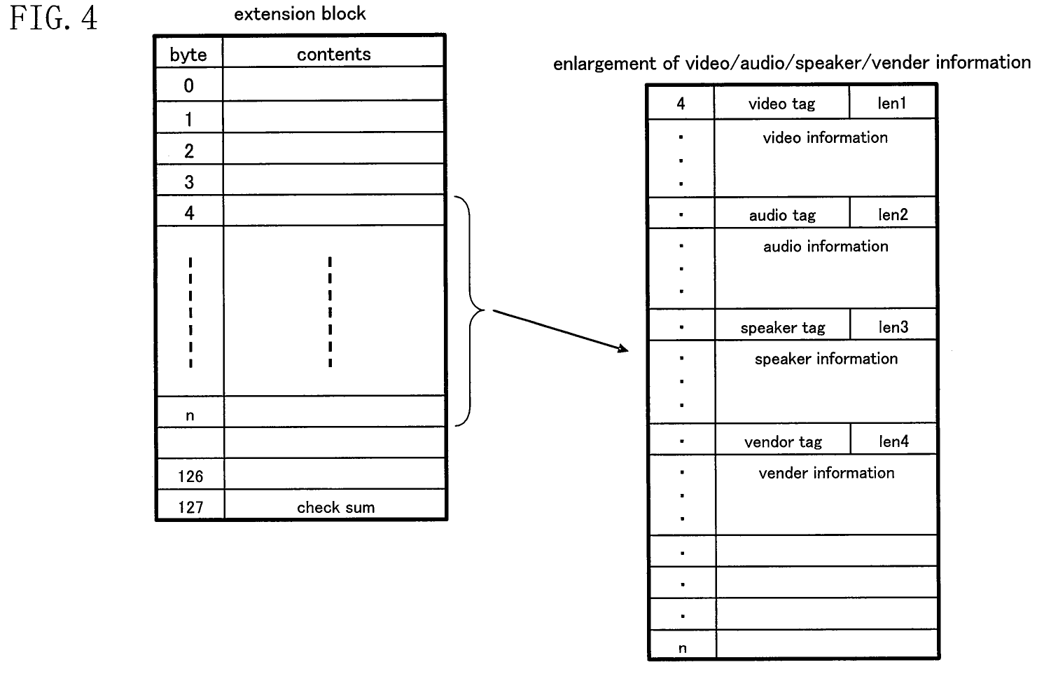

FIG. 4 is a diagram showing a structure of an extension block of the EDID information. In FIG. 4, information about a video resolution (480i, 720p, 1080i, etc.) and a color space (YCbCr4:4:4, RGB, etc.) that can be displayed by the audio/video reception apparatus 130 is written in a video tag. Information about an audio format (I²S, etc.) and audio frequency (48 kHz, 192 kHz, etc.) that can be reproduced by the audio/video reception apparatus 130 is written in an audio tag. Information about the number of audio channels that can be reproduced by the audio/video reception apparatus 130 is written in a speaker tag. Vender information is written in a vender tag.

When the audio/video transmission apparatus 100 and the audio/video reception apparatus 130 are connected to each other via the HDMI cable 180 and both the apparatuses 100 and 130 are powered ON, the hot plug output section 152 causes a hot plug signal to go from Low to High. The hot plug detecting section 112, when detecting the transition of the hot plug signal from Low to High, determines that the audio/video transmission apparatus 100 and the audio/video reception apparatus 130 are physically connected to each other, so that EDID information can be read out, and then instructs the EDID reading/determining section 111 to read out EDID information from the storage element 140.

It will be described how the EDID reading/determining section 111 and the type determining section 114 determine the type of the audio/video reception apparatus 130, with reference to FIG. 3.

The EDID reading/determining section 111, after reading out EDID information from the storage element 140, determines whether or not the structure of the EDID information includes an extension block (step 1). If an extension block is included, the EDID reading/determining section 111 determines that the audio/video reception apparatus 130 is an HDMI apparatus, and the process goes to step 2. If an extension block is not included, the EDID reading/determining section 111 determines that the audio/video reception apparatus 130 is a DVI apparatus, and the process goes to step 4-5.

In step 2, audio information belonging to the audio tag and the speaker tag included in the extension block is read out.

In step 3, the type of the audio/video reception apparatus 130 is determined based on the information read out in step 2. If the number of audio channels is two and the supported audio frequency is 48 kHz, the type of the audio/video reception apparatus 130 is determined to be a television set, and the process goes to step 4-1. If audio input is not permitted (not required), the type of the audio/video reception apparatus 130 is determined to be a projector, and the process goes to step 4-2. If the number of audio channels is up to eight and the supported audio frequency is up to 192 kHz, the type of the audio/video reception apparatus 130 is determined to be an AV amplifier, and the process goes to step 4-3. If the type of the audio/video reception apparatus 130 is determined to correspond to none of these types (i.e., determined to be unknown), the process goes to step 4-4.

In step 4-i (i=1 to 5), information for transmitting the type of the audio/video reception apparatus 130 determined in step 3 to the TMDS switching section 115 is set.

In step 5, the information set in step 4-i (i=1 to 5) is transmitted to the TMDS switching section 115.

The TMDS switching section 115 selects a TMDS signal output scheme and an InfoFrame packet output timing suitable for the audio/video reception apparatus 130 based on the information transmitted from the type determining section 114. For example, if the information indicates “television set”, a scheme A in FIG. 2A is selected. If the information indicates “projector”, a scheme B in FIG. 2B is selected. If the information indicates “AV amplifier”, a scheme C in FIG. 2C is selected. If the information indicates “unknown” or “DVI apparatus”, a scheme D in FIG. 2D is selected. After the scheme selection, an instruction to perform TMDS signal output and InfoFrame packet output using the scheme selected by the TMDS output section 113 is issued.

The TMDS output section 113 outputs a TMDS signal in accordance with the instruction from the TMDS switching section 115 in the following procedure. As in schemes of FIGS. 2A to 2D, the TMDS signal is output for a period of TA1 (or TB1, TC1 or TD1), then stopped for a period of TA2 (or TB2, TC2 or TD2), and then continuously output. An InfoFrame packet is output at a timing “P1” that is a time after a period of TA3 (or TB3, TC3 or TD3) has elapsed since the start of the continuous output. An authentication process is started at a timing “P2”. Output of audio/video information is started at a timing “P3” at which the authentication process is ended.

The output audio/video information is either one that has been received by the tuner 122 or one that has been reproduced by the audio/video recording/reproducing section 123. The input section 121 selects either one of the pieces of audio/video information, and also selects the type of audio, the resolution of output video and the like. The audio/video processing section 120 processes the audio/video information into a desired audio type and video resolution and outputs the resultant data to the TMDS output section 113.

The audio/video reception apparatus 130 processes the received audio/video information into audio and video that can be listened and viewed using the audio/video processing section 160, and outputs the resultant data to the audio/video output section 170. Stages following the audio/video output section 170 vary depending on whether the audio/video reception apparatus 130 is a television set, a projector, or an AV amplifier, and will not be described.

If the audio/video reception apparatus 130 is, for example, newly designed or slightly changed, then when the TMDS signal output scheme and the InfoFrame packet output timing of FIGS. 2A to 2D are used, a defective phenomenon may occur, e.g., an authentication process may fail, audio may not be output or a discomfort sound may be generated, video may not be output or may be disturbed, or the like. In this case, such a defective phenomenon may be reduced by adjusting TA1 (or TB1, TC1 or TD1), TA2 (or TB2, TC2 or TD2), or TA3 (or TB3, TC3 or TD3). Each time period can be adjusted by adjusting only a scheme corresponding to the type of the audio/video reception apparatus 130, i.e., it is not necessary to adjust the other schemes.

For example, if a newly designed television set is connected to the audio/video transmission apparatus 100, the TMDS signal output scheme and the InfoFrame packet output timing for the scheme A are selected. In this case, it is assumed that the process flow, process time or the like of the television set is changed, and therefore, a mismatch in process timing occurs between the television set and the audio/video transmission apparatus 100, so that neither audio nor video is output. It is also assumed that, as a result of adjustment, an improvement is achieved by elongating the time period TA3 by ΔT from the current state and delaying the InfoFrame packet output timing (hereinafter referred to as a “scheme A′” (not shown)). Although the scheme A′ is effective for the newly designed television set, it is not known at this time whether or not the scheme A′ is effective for a television set that conventionally does not have a problem. Therefore, the scheme A′ is used to verify connectivity with respect to the conventional television set, and if a problem does not arise, the scheme A′ is formally adopted and set as the scheme A. If a problem arises, additional measures, such as time adjustment or the like, are taken so as to find out a scheme suitable for both the television set that conventionally does not have a problem and the newly designed television set. This time adjustment is only for television sets, so that none of the scheme B for a projector, the scheme C for an AV amplifier, and the scheme D for others or a DVI apparatus is affected. Also, reverification of connectivity may be performed only with respect to the television set, i.e., reverification of connectivity is not required for the other types of apparatuses that have not been adjusted.

As described above, with the configuration of FIG. 1, a plurality of TMDS signal output schemes and a plurality of InfoFrame packet output timings corresponding to the types of audio/video reception apparatuses to be connected are provided, and the schemes are switched and output, depending on the type of a connected audio/video reception apparatus. Therefore, as compared to the conventional single-output scheme, a mismatch in process timing between the sender and the receiver can be reduced, thereby making it possible to reduce the phenomenon, such as a failure in authentication, the absence or disturbance of audio or video output, or the like.

Further, a TMDS signal output scheme and an InfoFrame packet output timing are set and adjusted only for a scheme corresponding to the type of the audio/video reception apparatus, and none of the other schemes (other types) is affected.

Further, connectivity reverification may be performed only for a scheme that has been set and adjusted, so that a verification time can be significantly reduced as compared to that in the conventional art, leading to a reduction in development cost.

Note that the TMDS signal output schemes and InfoFrame packet output timings selected by the TMDS switching section 115 are not limited to those shown in FIG. 2A to FIG. 2D.

Also, the method for determining the type of an audio/video reception apparatus that is performed by the type determining section 114 is not limited to that shown in FIG. 3.

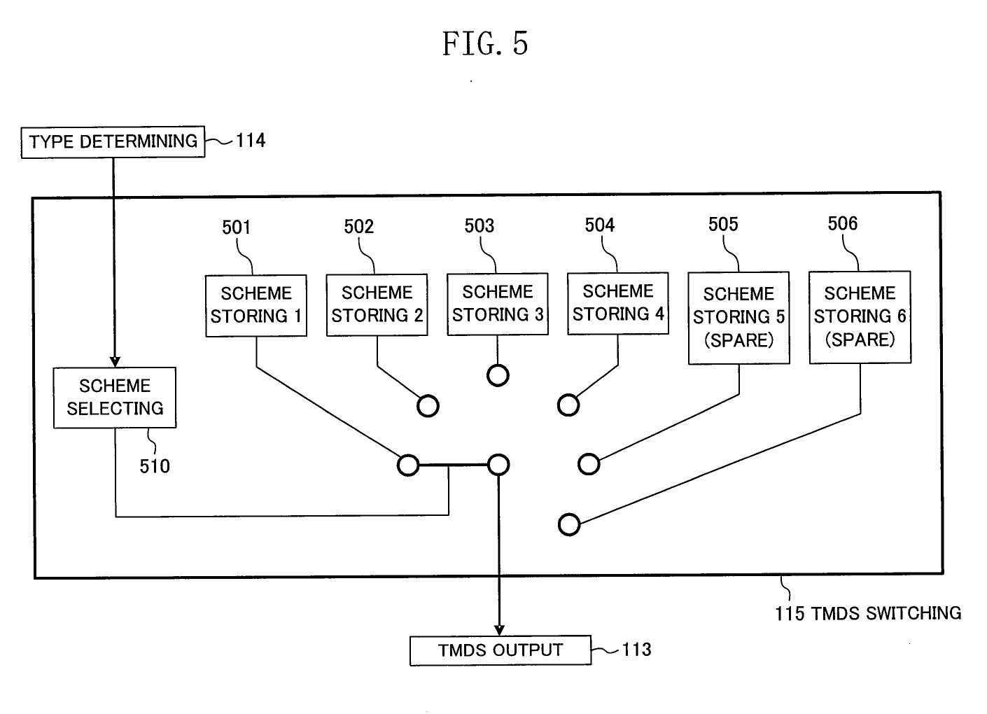

FIG. 5 is a diagram showing a configuration of the TMDS switching section 115. In FIG. 5, 501 to 504 indicate scheme storing devices 1 to 4 for storing information about TMDS signal output schemes and InfoFrame packet output timings, 505 and 506 indicate spare scheme storing devices 5 and 6 having the same function as that of the scheme storing devices 1 to 4, and 510 indicates a scheme selecting device for selecting one to be used from the scheme storing devices 1 to 6.

The TMDS switching section 115, when receiving information about the type of the audio/video reception apparatus 130 from the type determining section 114, selects a TMDS signal output scheme and an InfoFrame packet output timing suitable for the audio/video reception apparatus 130. For example, if the information indicates “television set”, the scheme storing device 1 of FIG. 2A storing the scheme A is selected. If the information indicates “projector”, the scheme storing device 2 of FIG. 2B storing the scheme B is selected. If the information indicates “AV amplifier”, the scheme storing device 3 of FIG. 2C storing the scheme C is selected. If the information indicates “unknown” or “DVI apparatus”, the scheme storing device 4 of FIG. 2D storing the scheme D is selected. After the scheme selection, the TMDS switching section 115 instructs the TMDS output section 113 to output a TMDS signal and an InfoFrame packet in accordance with the selected output scheme.

The scheme storing devices 5 and 6 prepared as spares store output schemes suitable for types other than a television set, a projector, an AV amplifier and others (including a DVI apparatus) stored in the scheme storing devices 1 to 4. Alternatively, the scheme storing devices 5 and 6 store output schemes for a peculiar television set, projector, AV amplifier and others (including a DVI apparatus) that cannot be supported by the output schemes stored in the scheme storing devices 1 to 4.

For example, there are assumed to be television sets manufactured by companies X, Y and Z. It is also here assumed that the television sets of the company X and Y can be supported by the scheme A stored in the scheme storing device 1, and the television set of the company Z is supported by none of the schemes. In this case, information about a TMDS signal output scheme and an InfoFrame packet output timing dedicated to the television set of the company Z is stored in the scheme storing device 5. In addition, the type determining section 114 is provided with an additional process of determining whether the type of the audio/video reception apparatus 130 is the television set of the company Z.

Instead of time adjustment of the scheme A for the type “television set”, the information about the TMDS signal output scheme and the InfoFrame packet output timing dedicated to the television set of the company Z is additionally provided, so that reverification is not required for television sets that conventionally do not have a problem.

As described above, a spare scheme storing device for storing a TMDS signal output scheme and an InfoFrame packet output timing is additionally provided, so that a peculiar apparatus, type or the like can be flexibly supported, thereby making it possible to improve the quality of connectivity of the audio/video transmission apparatus.

Further, connectivity reverification may be performed only with respect to an additional scheme, so that a time required for connectivity verification does not significantly increases and therefore development cost is reduced.

Note that the number of scheme storing devices is not limited to that of FIG. 5, and may be appropriately prepared, depending on the specifications of the audio/video transmission apparatus.

Incidentally, as shown in FIG. 1 with a dot-dashed line, each output scheme stored in the TMDS switching section 115 can be rewritten by the rewrite section 124. The input section 121 is used to input information about how rewriting is to be performed, information about which of the scheme storing devices 1 to 6 included in the TMDS switching section 115 is to be rewritten, or the like. As the rewrite section 124, a method of obtaining update information from the communications network 190 and performing rewriting, and a method of performing rewriting using a CD or DVD medium on which update information is written, are prepared.

When the communications network 190 is used, the audio/video transmission apparatus 100 needs to be previously connected to the communications network 190. The input section 121 instructs the rewrite section 124 to access a designated web site, download latest information about a TMDS signal output scheme and an InfoFrame packet output timing, and write the information to a designated scheme storing device i (i=1 to 6). The rewrite section 124 operates in accordance with the instruction.

When a CD or DVD medium is used, the input section 121 instructs the audio/video recording/reproducing section 123 to read update information written on the CD or DVD medium and transmit the information to the rewrite section 124, and instructs the rewrite section 124 to write update information from the audio/video recording/reproducing section 123 to a designated scheme storing device i (i=1 to 6). The rewrite section 124 operates in accordance with the instruction.

As described above, with the configuration of FIG. 1, a TMDS signal output scheme and an InfoFrame packet output timing can be easily rewritten by various means, so that the maintainability of the apparatus can be improved.

Note that when the audio/video transmission apparatus 100 supports reading and writing of a compact storage medium, such as an SD card or the like, the audio/video transmission apparatus 100 can cause the rewrite section 124 to perform a rewrite operation using information stored in the compact storage medium, as is similar to the case of a CD or DVD medium.

Further, a remote controller or the like accompanying the audio/video transmission apparatus 100 may be used to adjust a TMDS signal output scheme and an InfoFrame packet output timing. Thus, the rewrite section 124 is not limited to that described above.

As described above, the audio/video transmission apparatus of the present invention is useful for home-use audio/video apparatuses, such as a DVD player, a DVD recorder, a hard disk recording/reproducing apparatus, an AV amplifier, and the like.

What is claimed is:

1. An audio/video transmission apparatus connectable to an audio/video reception apparatus via a serial transmission interface, comprising:
a section for determining a type of the audio/video reception apparatus based on apparatus information about the connected audio/video reception apparatus; and
a section for selecting an information transmission signal output scheme corresponding to the type of the connected audio/video reception apparatus from a plurality of output schemes for an information transmission signal, and outputting the information transmission signal.

2. The audio/video transmission apparatus of claim 1, further comprising:
a section for adjusting and verifying the information transmission signal output scheme for each type of the audio/video reception apparatus.

3. The audio/video transmission apparatus of claim 1, further comprising:
a spare scheme storing device for storing information for specifying the information transmission signal output scheme.

4. The audio/video transmission apparatus of claim 1, further comprising:
a section for rewriting information for specifying the information transmission signal output scheme.

5. The audio/video transmission apparatus of claim 4, further comprising:
a section for updating the information for specifying the information transmission signal output scheme, using a communications network.

6. The audio/video transmission apparatus of claim 4, further comprising:
a section for updating the information for specifying the information transmission signal output scheme, using a readable storage medium.

7. The audio/video transmission apparatus of claim 1, wherein
the serial transmission interface is a High Definition Multimedia Interface (HDMI).

8. The audio/video transmission apparatus of claim 1, wherein
the apparatus information is Extended Display Identification Data (EDID) information.

9. The audio/video transmission apparatus of claim 1, wherein
the information transmission signal is a Transition Minimized Differential Signaling (TMDS) signal.

10. An audio/video transmission apparatus connectable to an audio/video reception apparatus via an HDMI interface, comprising:
a hot plug detecting section for detecting a hot plug signal output from the connected audio/video reception apparatus;
an EDID reading/determining section for reading EDID information of the connected audio/video reception apparatus, and determining a content of the EDID information;
a type determining section for determining a type of the connected audio/video reception apparatus based on a result of the determination of the EDID information;
a TMDS switching section for designating an output scheme corresponding to the type of the connected audio/video reception apparatus of a plurality of TMDS signal output schemes; and
a TMDS output section for outputting a TMDS signal in accordance with the output scheme designated by the TMDS switching section.

11. An audio/video transmission method for transmitting audio/video information via a serial transmission interface to an audio/video reception apparatus, comprising the steps of:
determining a type of the audio/video reception apparatus based on apparatus information of the connected audio/video reception apparatus; and
selecting an information transmission signal output scheme corresponding to the type of the connected audio/video reception apparatus from a plurality of output schemes for an information transmission signal and outputting the information transmission signal.
